(19) United States
(12) Patent Application Publication
(10) Pub. No.: US 2010/0216941 A1
(43) Pub. Date: Aug. 26, 2010

(54) INORGANIC-ORGANIC HYBRID CHEMICAL RESISTANT COATING

(75) Inventors: Henry LOMASNEY, Pagosa Springs, CO (US); Brenden Carlson, Seattle, WA (US)

Correspondence Address: PERKINS COIE LLP;PATENT-SEA, P.O. BOX 1247, SEATTLE, WA, 98111-1247, US

(73) Assignee: ISOTRON CORPORATION, Seattle, WA (US)

(21) Appl. No.: 12/542,656

(22) Filed: Aug. 17, 2009

Related U.S. Application Data
(63) Continuation of application No. PCT/US2008/054072, filed on Feb. 15, 2008.
(60) Provisional application No. 60/890,106, filed on Feb. 15, 2007.

(51) Int. Cl. C09D 5/08; C07F 7/02; C07F 7/28; C07F 15/02

(52) U.S. Cl. 524/588; 556/400; 556/9

(57) ABSTRACT

A silane-curing chemical resistant coating composition and methods for making and using the composition are provided. A coating can be manufactured, for example, by two simultaneous or sequential processes. In the first process an inorganic material such as silica or alumina with free amine or hydroxyl sites reacts with an organic moiety having a terminating functional group, such as an oxirane, amine or hydroxyl. In the second process, the material further reacts with an isocyanato, amino or other functional alkoxy, methoxy, acyloxy or other silane group. The terminal functional becomes an alkoxy, methoxy, alcyloxy or other silane that can cross-link with another such silane group on contact with moisture and/or upon absorption of ultraviolet light. Optionally, silane terminated polymers may be further added to contribute flexibility, hardness and other desirable physical properties. The coatings are applicable to various applications including environmentally benign, high performance industrial, military and automotive applications.

### FIELD OF THE TECHNOLOGY

The technology relates to coating compositions.

### BACKGROUND

Topcoat and primer systems are required to protect various substrates such as aluminum, steel, and composite substrates. The coating systems are used to minimize substrate corrosion, and resist contamination/degradation by industrial and environmental chemicals in the natural, industrial, automotive and military operational environments. Topcoats for these applications have historically been based upon two component solvent-based urethanes and acrylic systems. More recently single component solvent-borne and dual component water-dispersible urethane topcoats have been developed that achieve full-cure properties at room temperature within 7 days. This technology currently has volatile organic compound (VOC) levels of 210-420 WI, which is well above a desired VOC level of 0 g/l. Although the acrylic and urethane topcoat technologies produce coatings of satisfactory performance, requirements such as component mixing and application errors occur in the field with multi-component paints, which leads to less than acceptable results. The primer coatings must provide at least some resistance to contamination and degradation by chemicals as well. Good coating cohesive strength and good adhesion at the substrate-primer and primer-topcoat interfaces are essential to overall coating performance. Both the primer and the topcoat afford functionality to the overall performance of state-of-the-art industrial, automotive, and military systems.

### Chemical and Chemical Agent Resistant Coatings

Chemical agent resistant coatings (CARC) have been the standard camouflage for the United States military since 1985. A two-component urethane comprising an aliphatic diisocyanate and a saturated polyester was introduced at that time to meet the MIL-C-46168 specification. Such coatings resist penetration by chemical warfare agents with a longer service life and improved resistance to corrosion. Escarsega et al. (U.S. Pat. No. 5,691,410) teach a water dispersible, multi-part CARC comprising a polyurethane, a polyisocyanate, and primarily water as the solvent. This coating achieved a significant reduction in VOC but still required mixing at the point of application.

### Silane Terminated Polymer Coatings

Silane terminated polymers, specifically Silane Terminated Polyurethanes (STPs), have been used extensively in the sealants and adhesives industries and recently for industrial coatings. Frisch et al. claim numerous technologies relating to STPs. For example, U.S. Pat. Nos. 6,887,964 and 6,833,423 describe moisture curable polyether urethanes having reactive silane residues, and their use as sealants, adhesives and coatings, via reactivity of alkoxy or acyloxy silanes to an isocyanato residue. U.S. Pat. No. 6,855,759 depicts silica particles that are surface treated with silane, and processes for producing these. Preparation of metal free silane terminated polyurethanes using a non tin catalyst is shown in U.S. Pat. No. 6,784,272. Silicon encapped moisture curable compositions and methods of their construction are shown in U.S. Pat. No. 6,197,912 and silane-functionalized acrylic polymer compositions in the context of glass bonding are shown in U.S. Pat. No. 6,646,048. Also see U.S. Pat. Nos. 5,554,709, 4,857,623, 5,227,434, 3,632,557, 3,979,344, 4,345,053 and 4,645,816, which further describe silane terminated polyurethanes.

The art of silane terminated epoxy polymers have been previously practiced. Czechoslovakia patent 245889 (1985, Aromatic Disilanes) teaches the method of functionalization of bisphenol-A epoxy resins with aminopropyltrialkoxysilanes. The method describes the preparation of said compounds and their utility towards glass fiber coatings. In Japan there have been numerous descriptions of silane terminated epoxy resins and their utility as gas barrier films for the food industry. The methods of preparation of trialkoxysilane terminated bisphenol-diglycidyl ether and resorcinol diglycidyl ether and their utility are taught in Japanese patents 2001192485, 2001191445, 2000326448, and 2000327817. International patent WO 01/08639 describes the utility of several trialkoxy silane terminated acrylic and acrylic epoxy macromers for utility in the field of dentistry. In all these patents the method of curing the monomers/macromers into large polymer networks by the hydrolization of alkoxysilane moieties with water vapor to silanol, and then the condensation of silanol to crosslink to a polymer network is described.

### Surface-Modified Metal Oxides

Metal oxides often exist as particles having surfaces that may be modified for use as coatings. See for example, U.S. Pat. No. 5,026,816 by Keehan, which describes a method and oxirane pre-polymer material that forms from a metal oxide and an oxirane polymer. Also see U.S. Pat. No. 6,369,183 by Cook et al., who teach a polymer composition based on reaction of alumoxane, which is a special form of aluminum oxide, with a reactive polymer and U.S. Pat. No. 6,855,859 by Kudo et al., in which a silane treatment is provided to silica particles in order to increase dispersability by preventing re-agglomeration.

Despite this and other related work, the present chemical and corrosion resistant coating systems remain problematic in two ways. One, VOC solvents used in these coatings impact the environment and, for example, can contribute directly to smog formation. As a result, the coatings industry is taking an aggressive position to reduce the VOC content in its specified coatings.

A second problem generally with present coating systems arises from the use of urethanes and is related to the health impact on coating applicators. In addition to potential VOC solvents, isocyanates found in urethanes are known to cause problems in the respiratory system and are harsh skin and mucous membrane sensitizers.¹ There is a cause for alarm in the adverse health effects relating to exposure to hexamethylene diisocyanate (HDI), including the inhalation of airborne droplets containing HDI released during spray application of current urethane coatings. Systemic effect studies have determined that inhalation exposure can cause asthma, shortness of breath and other respiratory distress effects.² Safe handling of isocyanate materials requires that the persons exposed to these vapors be protected with air supplied respirators, and protective suits that assure that the uncured coating cannot be inhaled or contact the skin. It is desirable to achieve a chemical and corrosion resistant coating that reduces or eliminates both these problems. ¹ United States Naval Flight Surgeon's Manual: Third Edition 1991: Chapter 21: Toxicology: Isocyanate² International Consensus Report on: Isocyanates—Risk assessment and management (http://www.arbeidstilsynet.no/publikasjoner/rapporter/pdf/rapport1c.pdf)

### SUMMARY OF THE TECHNOLOGY

Problems with many present day coating systems can be alleviated by the use of a silane cross-linking with an inorganic-organic hybrid coating composition that uses inorganic media as a scaffold for the cross-linking. The combination of inorganic material with multiple organic attachments having terminal functional residues such as oxirane, amine or hydroxyl is further modified by reaction with a silane residue. This results in terminal functional residues that become alkoxy, methoxy, alcyloxy or other silanes that can cross link with another silane residue on contact with moisture. Thus, in one embodiment, two reactions, which may occur simultaneously or serially, are used to form a single pack coating composition.

A variety of materials can be used to form and use single pack coating compositions as described herein. A variety of inorganic materials, coupled organic compounds (hereinafter “organic moieties”), and silane chemistries may be employed, as described next. In embodiments, the coating formed using the technology of the disclosure has a VOC of 0 g/l to 210 g/l (e.g., 0 to 100 g/1; 0 to 50 g/1; 10 to 20 g/l).

### Suitable Inorganic Materials

Suitable inorganic materials are inorganic oxides comprising at least one hydrolyzable oxygen. For example, inorganic materials used in this technology include particles of one or more metal oxides. The oxygen atoms of the metal oxides are bound at the surfaces of the particles such that these oxygen atoms are free to interact with the organic moieties. Examples of inorganic materials used in this technology include but are not limited to silica, aluminum oxide, magnesium oxide, titanium oxide, zirconium oxide, tin oxide, nickel oxide, antimony oxide, zinc oxide, iron oxide, molybdenum oxide, and combinations of these. Silica and/or aluminum oxide are two preferred oxides. Most preferably silica is used. Particle size may cover a wide range of diameters, including micron-scale particles, that is particles of mean diameter ranging from 1 μm to 1 mm, and nano-scale particles, that is particles of mean diameter ranging from 1 nm to 1 μm. For example, in one embodiment the particles can have a range of diameters from 0.5 nm to 10 nm. In another embodiment the particles can have an average diameter range of 10 nm to 100 nm or 10 nm to 1000 nm. In other embodiments the particles can have an average diameter range of 500 nm to 500 μm. In another embodiment the particles can have an average diameter range of 10 μm to 1 mm. Other ranges are also possible. These particles may serve to lower shrinkage on curing, to decrease thermal expansion coefficients, to improve thermal conductivity, and to impart increased durability and hardness to the cured coating. Smaller diameter particles (e.g., 0.5 nm to 500 nm; 10 nm to 100 nm; 5 nm to 50 nm) may improve the mechanical and impact resistance properties of the coating but too high a loading of these particles makes the coating too viscous for simple manufacturing. Larger diameter particles (e.g., 10 μm to 100 μm; 50 μm to 500 μm; 100 μm to 1 mm) may be used in mixtures with smaller diameter particles to achieve the other desired properties without significant loss of durability and hardness benefits imparted by the smaller diameter particles.

### Suitable Organic Moieties for Coupling to Inorganic Materials

Organic moieties for coupling to the inorganic materials should have functionality to react with the hydrolyzable oxygen on the inorganic materials. Such moieties include but are not limited to oxirane, amine, hydroxyl, carboxy, and thiol (e.g., an organic moieties of 1 to 2000 carbons). A catalyst may be added to induce or accelerate the coupling reaction. For example, Keehan teaches use of an imidazole catalyst in the reaction of a dioxirane with silica (U.S. Pat. No. 5,026,816). With hydroxyl and thiol moieties, a tertiary amine catalyst may be used to accelerate the condensation of said moieties with the surface of an inorganic material or other materials. Catalysts such as those based upon tin and titanium may also be used.

### Silane Chemistries

Silane chemistries are chosen with functionality to react with the organic moiety to form an organic moiety of 1 to 2000 carbons including a terminal reactive silane group. Such functionalities include amino, mercapto, isocynato, and epoxide functions. These functions are attached to a silicon atom by way of a hydrocarbon chain between one and ten carbons in length, more preferably between one and three carbons in length. Hydrocarbon side chains may be attached to the primary hydrocarbon chain between the silicon atom and the functionality. These side chains may provide steric hindrance and/or favorably alter the kinetics of the coupling reaction between the organic moiety and the silane. In the case of an amino functional group, the amino group may be a primary or secondary amine, and for the secondary amine, another hydrocarbon chain may be attached for greater steric hindrance and or to attach another silicon atom to create a bis-amino silane. Also attached to the silicon atom are two or three alkoxy groups. The alkoxy groups are hydrolyzed by moisture from the atmosphere after the coating is applied to a surface. The resulting silanol functionalities then condense to create crosslinks, thereby curing the coating. Optionally the condensation occurs in the presence of a catalyst, for example dibutyltin dilaurate. Examples of acceptable silane chemistries include bis(3-triethyoxysilylpropyl)amine, N-ethyl-aminoisobutyltrimethoxysilane, gamma-mercaptopropyltrimethoxysilane, N-cyclohexylaminomethyltriethoxysilane, and gamma-isocyanatopropyltriethoxysilane.

### Reaction/Use Conditions

Reactions to couple the organic moiety to the inorganic material are known in the art. Teachings have been provided by Keehan and others. In one example, (U.S. Pat. No. 5,026,816), resorcinol diglycidyl ether, silica and an imidazole catalyst are mixed in a high-shear mixer at an initial temperature of 100-135° C. for 30 minutes to two hours to evaporate any moisture present. The temperature is increased to a predetermined temperature of 140-220° C. and the reaction proceeds for one to four hours. Mixing and reacting may take place under vacuum to remove more completely any residual moisture.

The silane chemistry is chosen with functionality to react with the organic moiety by reactions known in the art. In one example, an aminosilane is mixed in a dry environment, e.g. under an argon blanket, with an epoxy moiety at 60-80° C. for 30 minutes to two hours. It is important to maintain a moisture-free environment for the mixing in order not to initiate premature curing of the silylated organic-inorganic hybrid that is prepared in this step. The silylated organic-inorganic hybrid may be formulated into a finished coating product suitable for brush or spray application by addition of colored pigments, flatting agents, solvent, rheology modifiers, and other additives known in the art.

A desirable embodiment provides a coating composition as a single pack system, which is cured on contact with moisture and/or from ultraviolet light. Such moisture and light could be supplied from the environment, such as from humidity in the air. By using a single pack composition, complexity of using a second component for reaction, as generally taught in the art, can be minimized. For example, a reactive oxirane system as taught by Keehan requires reaction with an epoxy hardener to complete the curing process. In the case of the carboxylate alumoxane taught by Cook et al., a “chemically reactive substituent” is required to form the polymeric compound.

### EXAMPLE 1

Take 277 g of hydrogenated bisphenol-A diglycidyl ether and mix with 85 g silica and 0.4 g of imidazole catalyst in a container. Place the container under vacuum and vigorously stir for 2 hours. While still under vacuum, heat the mixture to 345° F. for two hours. Cool to 200° F., flood with argon, and add 182 g of 3-mercaptopropyltrimethoxysilane. Perform a cycle of 3 purges of argon. Gently heat the system to 251° F. under argon for two hours. Cool the system to room temperature and add a dried, anhydrous pigment mixture to add color. In this example a tan color was produced by the addition of 38.9 g yellow 42, 3.4 g of red iron oxide, 0.6 g of carbon black, and 117.1 g of titanium dioxide. The mixture was rapidly stirred under vacuum to disperse the pigments.

A coating was prepared from the above resin mixture by taking 58.6 g of the resin, and mixing in 9.0 g of polypropylene beads, 6.0 g of organic-treated silica, and 0.1 g of aerogel. The solution was thinned with 85 g of p-chlorotrifluoromethyl benzene. To this was added 0.5 g of dibutyl tin dilaurate as a cure catalyst. This solution may be spray applied to substrates.

After 25 hour cure (from the moisture in the environment), the coatings formed from this mixture exhibited a 85° gloss of 2.5, 60° gloss of 1.0, resisted 250 double rubs of both 2-butanone and methylene chloride. The coating also survived an immersion in acetic acid (10% in water) for 1 hour 30 minutes, and survived 3 days of exposure to a decontamination solution DS-2.

### EXAMPLE 2

Take 250 g of hydrogenated bisphenol-A diglycidyl ether and mix with 77 g silica and 0.5 g of imidazole catalyst in a container. Place the container under vacuum and vigorously stir for 2 hours. While still under vacuum, heat the mixture to 345° F. for two hours. Cool to 200° F., flood with argon, and add a pigment mixture to add color. In this example a green coating was desired. To achieve this a pigment mixture of 4.048 g carbon black, 36.08 Hostaperm green, and 120.16 g of Bayferrox iron yellow was added and dispersed under vacuum at a temperature of 250° F. After cooling to 200° F. and flooding with argon, 302 g of N, N-bis(3-triethoxysilylpropyl)amine was added. Perform a cycle of 3 purges of argon and then evacuate. Gently heat the system to 251° F. under vacuum for two hours.

A coating was prepared from the above resin mixture by taking 55.0 g of the resin, and mixing in 9.0 g of polypropylene beads, 6.0 g of silica, and 0.1 g of aerogel. The solution was thinned with 85 g of p-chlorotrifluoromethyl benzene. To this was added 0.5 g of dibutyl tin dilaurate as a cure catalyst. This solution may be spray applied to substrates.

After 24 hour cure (by moisture in the environment), the coatings were still soft and flowable. The coatings were dry to the touch after 48 hours. After a week of cure the coatings formed from this mixture exhibited a 85° gloss of 1.7, 60° gloss of 0.5, and resisted 200 double rubs of 2-butanone. The coating also survived an immersion in acetic acid (10% in water) for 1 hour 10 minutes.

### EXAMPLE 3

Take 376 g of hydrogenated bisphenol-A diglycidyl ether and mix with 115.4 g silica and 0.5 g of imidazole catalyst in a container. Place the container under vacuum and vigorously stir for 2 hours. While still under vacuum, heat the mixture to 345° F. for two hours. Cool to 200° F., flood with argon, and add a pigment mixture to add color. In this example a green coating was desired. To achieve this a pigment mixture of 6 g carbon black, 54 g Hostaperm green, and 180 g of Bayferrox iron yellow was added and dispersed under vacuum at a temperature of 250° F. After cooling to 200° F. and flooding with argon, 243 g of N-ethyl-2-methylpropyltrimethoxysilane was added. Perform a cycle of 3 purges of argon and then evacuate. Gently heat the system to 251° F. under vacuum for two hours.

A coating was prepared from the above resin mixture by taking 55.0 g of the resin, and mixing in 9.0 g of polypropylene beads, 6.0 g of silica, and 0.1 g of aerogel. The solution was thinned with 85 g of p-chlorotrifluoromethyl benzene. To this was added 0.5 g of dibutyl tin dilaurate as a cure catalyst. This solution may be spray applied to substrates.

After 24 hour cure (from moisture in the environment), the coatings were dry to the touch. After 5 days of cure the coatings formed from this mixture exhibited a 85° gloss of 1.5, 60° gloss of 0.7, and resisted 200 double rubs of 2-butanone. After a week cure the coating survived an immersion in acetic acid (10% in water) for 1 hour.

### EXAMPLE 4

Take 200 g of resorcinol diglycidyl ether and mix with 98.3 g silica and 0.3 g of imidazole catalyst in a container. Place the container under vacuum and vigorously stir for 45 minutes while heating to 75° C. While still under vacuum, heat the mixture to 145° C. for two hours. Cool to 110° C., and add a pigment mixture to add color. In this example a green coating was desired. To achieve this a pigment mixture of 3.6 g carbon black, 16.4 g Hostaperm green, and 92 g of Bayferrox iron yellow was added and dispersed under vacuum at a temperature of 110° C. After cooling to 75° C. and flooding with argon, 74.5 g of a polyoxypropylenediamine was added and mixed for five minutes to increase the prepolymer's chain length. Still maintaining the mixture at or above 65° C., 188 g of N-ethyl-2-methylpropyltrimethoxysilane was added drop-wise over 30 minutes and mixed for an additional 30 minutes. The mixture was cooled, blanked under argon, and left to sit overnight.

Separately, to 289.5 g of a polyisocyanate was added drop-wise 333 g of N-ethyl-2-methylpropyltrimethoxysilane. The mixture was stirred under an argon blanket and heated to 70° C. One hour after the addition was completed, this silylated polyisocyanate was cooled stored under argon until needed.

The following day to prepare the coating, 250 g of the first mixture described in this example was heated under argon back to 60° C. with 9.3 g of vinyltrimethoxysilane as a moisture scavenger. Ten minutes after adding the vinyltrimethoxysilane, 5.5 g of silica aerogel was added over another 10 minutes of mixing. To the mixture next were added 70 g of polypropylene beads and 5 g of organic-treated silica, and mixing was continued, still under argon, for 95 minutes. During this time, a slurry of 337 g p-chlorotrifluoromethyl benzene, 43.1 g organic-treated silica, and 8.5 g vinyltrimethoxysilane was prepared. At the end of the 95 minutes mixing, the slurry and 114.7 g of the silylated polyisocyanate described above were added to the main mixture and mixed at 60° C. under argon for an additional 20 minutes. Finally 5.7 g of a ultraviolet light absorber, 5.7 g of a hindered amine light stabilizer, 1.6 g dibutyl tin dilaurate, and a final 82.7 g p-chrlortrifluoromethyl benzene were added and mixed under argon as the mixture cooled to yield the final product for coating. This product was suitable for brush application and was thinnable with additional solvent for spray application. The coating was cured upon the application of a UV light source.

We claim:

1. An inorganic and organic matrix single pack composition suitable for forming a coating, comprising:
a. particles comprising one or more metal oxides with oxygen bound in the form of metal oxide at their surfaces, and
b. organic moieties of 1-2000 carbons reacted to the surface metal oxides via oxygen linkages, the organic moieties comprising terminal reactive silane groups, wherein the terminal silane groups of the organic moieties are capable of controllably crosslinking in the presence of at least one of moisture or ultraviolet light to form a coating.

2. The single pack composition of claim 1, wherein the organic moieties comprise terminal residues selected from the group consisting of amine, isocyanate, hydroxyl and oxirane-reactive residues.

3. The single pack composition of claim 1, wherein the metal oxide is selected from the group consisting of silica, alumina, cerium oxide, manganese oxide, magnesium oxide, titanium dioxide, zinc oxide and iron oxide.

4. A kit for forming a coating, comprising the single pack composition of claim 1, in a package that is resistant to ultraviolet light and moisture.

5. A method for making a coating, comprising,
a. forming an inorganic particle matrix by reacting particles that have at least one of free amine and free hydroxyl sites, with one or more organic moieties that comprise terminal functional residues; and
b. reacting the particles with a silane reagent to generate terminal functional silane residues that can cross-link with other silane residues on contact with moisture or ultraviolet light.

6. The method of claim 6, wherein step b occurs simultaneously with step a.

7. The method of claim 6, further comprising the step of adding silane terminated polymers.

8. The method of claim 6, wherein the terminal functional residues of the one or more organic moieties of step a are selected from the group consisting of an oxirane, an amine and hydroxyl.

9. The method of claim 6, wherein the reagent of step b is selected from the group consisting of an isocyanato, amino or other functional alkoxy, methoxy, or acyloxy orsilane.

10. A coating prepared by the method claim 6.

11. A single pack coating composition, which:
a. contains 5-100% of a pre-polymer, wherein said pre-polymer comprises a metal oxide particle containing hydrolyzable oxygen at its surface and organic moieties containing 1 to 2000 carbon atoms and terminating with a reactive silane group, the organic moieties and the metal oxide particle being linked at said hydrolysable oxygen; and
b. is cured through the reaction of silane groups in the presence of moisture or UV light.

12. The single pack coating of claim 11, wherein the cured pre-polymer contains an aromatic group.

13. The single pack coating of claim 11, wherein the cured pre-polymer contains a cyclo-aliphatic group.

14. The single pack coating of claim 11, wherein the organic moieties are reacted with the metal oxide particle through an esterification reaction.

15. The single pack coating of claim 11, wherein the organic moieties are reacted with the metal oxide particle through a hydrolysis reaction.

16. The single pack coating of claim 15, wherein the hydrolysis reaction is achieved through the reaction of a carboxylic acid with the metal oxide particle surface.

17. The single pack coating of claim 11, wherein the organic moieties are reacted with the metal oxide particles reaction through a reaction of an oxirane moiety with the metal oxide particle surface.

18. The single pack coating of claim 11, wherein the pre-polymer is synthesized in two steps.

19. The single pack coating of claim 18, wherein the first step in pre-polymer synthesis results in a material that is terminated in amine, isocyanate, hydroxyl or oxirane-reactive groups.

20. The single pack coating of claim 18, wherein second step involves silylation of the pre-polymer through the reaction of an amine, isocyanate, oxirane or hydroxyl-functional silane.

21. The single pack coating of claim 11, wherein the metal oxide comprises at least one of: silica, alumina, cerium oxide, manganese oxide, magnesium oxide, titanium dioxide, zinc oxide or iron oxide.

22. The single pack coating of claim 11, wherein the volatile organic compound level is 0-210 g/l.
